(19) United States
(12) Patent Application Publication
(10) Pub. No.: US 2018/0310138 A1
(43) Pub. Date: Oct. 25, 2018

(54) MBMS Switching Improvement

(71) Applicant: Telefonaktiebolaget LM Ericsson (publ), Stockholm (SE)

(72) Inventors: Jinyang Xie, Shanghai (CN); Jie Ling, Shanghai (CN); Hongxia Long, Shanghai (CN); Woods Wang, Shanghai (CN)

(21) Appl. No.: 15/769,373

(22) PCT Filed: Oct. 22, 2015
(86) PCT No.: PCT/CN2015/092522

§ 371 Date: Apr. 19, 2018

(51) Int. Cl. H04W 4/06; H04L 29/06; H04W 36/00; H04W 76/25; H04W 76/40

(52) U.S. Cl. CPC H04W 4/06; H04L 65/1083; H04L 65/102; H04L 65/1069; H04W 76/40; H04L 65/4084; H04W 36/0011; H04W 76/25; H04L 65/4076

(57) ABSTRACT

There is provided a method in a wireless communications network, the method comprising: broadcasting a content stream as a broadcast service to at least one device using the wireless communications network; and sending to the at least one device a broadcast service status message, the broadcast service status message including the service areas for which the broadcast service will soon cease. By receiving an indication that the broadcast service will cease, before the broadcast service is stopped, the device can take steps to avoid buffer under-run, such as requesting and setting up a unicast service of the same content.

### TECHNICAL FIELD

The present application relates to a method in a wireless communications network, a method in a device arranged to communicate with a wireless communications network, a wireless communications network, a device arranged to communicate with a wireless communications network, an apparatus, and a computer readable medium.

### BACKGROUND

Multimedia Broadcast Multicast Service (MBMS) is a point-to-multipoint interface for cellular networks. It is designed to provide delivery of services common to a plurality of users making efficient use of both cell as well as core network resources. For broadcast transmission across multiple cells, it defines transmission via single-frequency network configurations. Target applications include mobile TV and radio broadcasting, as well as file delivery and emergency alerts.

eMBMS is the LTE version of MBMS that is offered via Evolved Packet Systems including UTRAN (Universal Terrestrial Radio Access Network) and E-UTRAN (LTE) access. This is typically used to deliver media content such as video and audio to user equipment (UE) in highly gathered areas, for example a stadium. An eMBMS system can use the MBMS Download Delivery Method (User Datagram Protocol (UDP) or File Delivery over Unidirectional Transport (FLUTE)) as a protocol to deliver Live TV content to terminals. Media contents according are delivered as segment files in accordance with Dynamic Adaptive Streaming over HTTP (DASH) using MBMS Download.

eMBMS may also be used for the distribution of top on-demand files i.e. operating system updates to the UEs. The eMBMS system can use the MBMS Download Delivery Method (UDP/FLUTE) as protocol to deliver top popular files such as Android update, YouTube clip preloading, or top popular movies.

FIG. 1 illustrates a basic implementation of an eMBMS system. A content provider 110 has content delivered to a plurality of user equipment 100 over a wireless communications network 200. The wireless communications network 200 is shown as comprising some network equipment 210, an MBMS Gateway 240 and a plurality of base stations, E-UTRAN 250 each having a service area 255, which in this case is the cell area. The MBMS Gateway 240 receives a single content stream from content provider 110 and arranges for common delivery of that content stream to each of the three UEs 100. In eMBMS, the user services are described in 3GPP TS 26.346.

User Service Bundle Description can be thought of as a one-to-group user service. It may contain one or more User Service Description instances, and may also refer to a single FEC Repair Stream Description. The User Service Description instance contains one or more Delivery Method descriptions, which is used to describe how the service is delivered to UE. The Delivery Method description refers to a Session Description instance, which describes the delivery related parameters. An Associated Delivery Procedure Description may also be referenced by Delivery Method description to provide the complementary delivery method for the service (e.g. file repair and reception reporting in eMBMS).

An MBMS User Service containing multiple content components may be carried on a single MBMS delivery session, or on multiple delivery sessions. The UE can expect to receive MBMS data during the described time period(s) when at least one of the sessions for the User Service is active.

The Schedule Description fragment may also include the schedule for when the files of a download delivery MBMS User Service are to be transmitted. The schedule information contains a schedule update time, allowing the UE to know when to update its current schedule. The UE may only activate reception of that service within the sessionSchedule (and the fileSchedule if present) time window.

A sessionScheduleOverride element is defined as a child of the serviceSchedule element. If included, the sessionScheduleOverride element indicates either the cancellation of the session occurrence, or schedule override, as follows:
If the cancelled attribute (a child of sessionScheduleOverride element) is set to “true” or “1”, then the transmission of the session identified by the index attribute (a child of sessionScheduleOverride element) is cancelled, and the UE shall cancel any applicable file repair and/or reception reporting for all files belonging to that session. If this session schedule-level cancellation indication in the updated schedule description is received after any of the associated files have already been delivered, then any related file repair, or reception reporting for those files (associated with their parent service(s)), either in progress or yet to occur, shall be aborted.
If the cancelled attribute (a child of sessionScheduleOverride element) is set to “false” or “0” or is absent, then the start and stop time elements (children of sessionScheduleOverride element) shall override the nominal start and stop time of the transmission schedule of the session as identified by the index attribute (a child of sessionScheduleOverride element).

A Schedule Description fragment may be delivered as a metadata fragment on the service announcement channel and may be updated in-band with an MBMS download session.

The session is also updated due to service area change. A Broadcast-Multicast Service Center (BM-SC) initiates the MBMS Session Update procedure when the service attributes (e.g. Service Area or ARP) for an ongoing MBMS Broadcast service session shall be modified, e.g. the Session Update procedure for EPS is initiated by BM-SC to notify eNBs to join or leave the service area.

A Session Update received in one node, results in a Session Update being sent to downstream nodes, to inform of the changed MBMS service attributes. If a Session Update with the List of MME and SGSN parameter included is received in the MBMS Gateway (MBMS GW), it does also result in a Session Start being sent to new downstream nodes, and in a Session Stop being sent to downstream nodes that have been removed from the list.

The overall Session Update procedure is presented in FIG. 2, which is a messaging diagram showing messages between a UE 100 and a wireless communications network 200. The wireless communications network 200 comprises a an E-UTRAN 250, a Serving GPRS Support Node—Mobility Management Entity (SGSN/MME) 245, an MBMS Gateway 240, and a BM-SC 235.

BM-SC 235 initiates the session update with a session update request message 201 sent to the MBMS GW 240. The MBMS GW 240 responds to the BM-SC 235 with a session update response message 202, and also sends a session update request message 203 to the MME/SGSN 245. MME/SGSN 245 receives the session update request message 203 from the MBMS GW 240 and sends a session update request message 204 to the E-UTRAN 250. The E-UTRAN 250 acknowledges the session update with a session update response message 205 sent to the MME/SGSN 245, which in turn sends another session update response message 206 to the MBMS GW 240. As part of the session update, the E-UTRAN 250 arranges for RAN resource setup or release 207, managing any connected UE's 100 appropriately. Further the E-UTRAN 250 may arrange for IP multicast join or leave 208.

Session update is necessary because, for the scheduled broadcast service, the broadcast session may need to be closed to leave the network resources for another scheduled service or an emergency service. Both of them will use the session update procedure to respectively remove and add the service area for the ongoing eMBMS session.

Some certain content will be initially delivered in unicast access, will be turned into broadcast in specific area when the traffic volume exceed the threshold to offload the network traffic load. This is termed MooD (MBMS operation on Demand), and it also allows for the broadcast in a specific area to be turned off when the broadcast consuming users in this area is less than a threshold. The MooD will use the session update procedure to add/remove the service area for the ongoing eMBMS session.

UE will activate reception of that service based on the sessionSchedule (and the fileSchedule if present) time window, it will continuously receive the broadcast content until it receives the in-band schedule cancelled or broadcast stop notification.

For the service area update scenario, BM-SC cannot send the sessionScheduleOverride fragment with ‘cancel’ equal to ‘true’ since the eMBMS session is still ongoing. That is, a sessionScheduleOverride with ‘cancel’ set as ‘true’ will terminate the multicast session for all UEs. A system information block (SIB) could operate to remove a single service area from a multicast service, but due to power demands a UE cannot monitor the SIB message continuously.

In practice, the UE will learn that its service area has been removed from the multicast session when it stops receiving the broadcast content. At that point the US may elect to transfer to unicast access if the broadcast content is also available by that mechanism. However, the UE must now set up the unicast access after it detects the broadcast service was down. This will result in a buffering under-run and service discontinuity.

FIG. 3 illustrates the above described problem. The broadcast signal 301, The UE access to that signal 302 and the UE buffer status 303 are all shown relative to the same time axis. At time 312 the broadcast service for the service area the UE is in is stopped. For example, the BM-SC may determine that resources in this service area should be released for other uses. However, the service is not stopped completely and continues in other service areas. Accordingly, the schedule update can't be delivered either in-band or out-of-band as the session was not stopped.

After the broadcast service is topped at time 312, the UE buffer 303 begins to under-run at 313. A short while later at 314 the US detects that the broadcast signal is no longer available and requests a unicast transmission of the same content. It takes until time 316 for the unicast reception to be set up and until time 318 until the UE buffer 303 is re-filled and the buffer under-run ends.

Therefore, there is a need for improved MBMS switching.

### SUMMARY

Informing the client device which service areas the broadcast service will soon cease in allows the client device to prepare for the end of the broadcast service and avoid buffer under-run. Such preparation may include requesting a unicast service of the same content allowing for a seamless switch from one content source to another.

The client is informed about which service areas the broadcast service will cease by inclusion of the specific service areas in sessionScheduleOverride fragment. This is done when the cancelled attribute is set to true. The sessionScheduleOverride may be delivered in-band of the session before BM-SC update (stop) the eMBMS session. The UE may receive the sessionScheduleOverride in in-band delivery and it may then setup the unicast access in advanced before the broadcast session is stopped.

This is useful if the number of service areas receiving the broadcast service is reduced. This reduction may be triggered by the network operator. Further, where MBMS operation on demand (MooD) is implemented, the delivery broadcast area may be shrunk in response to the broadcast traffic volume size dropping below a threshold.

In one embodiment, the BM-SC sends a modified sessionScheduleOverride message update in in-band delivery when it identifies that the delivery broadcast area will shrink. Upon reception of this message the UE may then setup a unicast access in advance of the broadcast service stopping to achieve the seamless switch from broadcast to unicast.

Accordingly, there is provided a method in a wireless communications network, the method comprising: broadcasting a content stream as a broadcast service to at least one device using the wireless communications network; and sending to the at least one device a broadcast service status message, the broadcast service status message including the service areas for which the broadcast service will soon cease. By receiving an indication that the broadcast service will cease, before the broadcast service is stopped, the device can take steps to avoid buffer under-run, such as requesting and setting up a unicast service of the same content.

The method may further comprise determining that the service areas for which the broadcast service is available should be changed to a revised set of service areas. The method may further comprise sending to the at least one device a further broadcast service status message, the further broadcast service status message including the service areas for which the broadcast service is currently available, but that are not in the revised set of service areas. The method may further comprise after a delay subsequent to the broadcast service status message being sent, broadcasting the content stream as a broadcast service in the revised set of service areas. The service area may change due to implementation of an on-demand broadcast service. The delay is a short time interval. The delay is sufficiently long for a device to switch from the broadcast service to a unicast service.

There is further provided a method in a device arranged to communicate with a wireless communications network, the method comprising receiving a content stream as a broadcast service from the wireless communications network. The method further comprises receiving a broadcast service status message, the broadcast service status message including the service areas for which the broadcast service will soon cease. The method further comprises determining, in response to the broadcast service status message, whether to leave the broadcast service and request a unicast service of the content stream. The device may request a unicast service of the content stream.

If the broadcast service status message includes the service area the device is in, the device may determine that it will leave the broadcast service and should request a unicast service of the content stream. Otherwise, if the device finds its location is not included in service areas of broadcast service status message, the device may determine that it can continue to receive the broadcast service.

If the device receiving the broadcast service detects it is moving into a service area included in the most recent broadcast service status message, then the device may determine that it will leave the broadcast service and should request a unicast service of the content stream.

If the device receiving the broadcast service detects it is moving into a service area not included in the most recent broadcast service status message, then the device may determine that it can continue to receive the broadcast service.

The broadcast service may be MBMS. The device may be a mobile device. The device is a UE. The device may be an in car entertainment system. The service area may be a cell of a wireless communications network. The service area may be identified by a service area identifier. The service area may be an MBMS Service Area identified by a Service Area Identity (SAI). The service area may be a cell identified by a Cell Global Identifier (CGI), or an enhanced Cell Global Identifier (eCGI).

There is further provided a wireless communications network, comprising a plurality of transmitters, each transmitter having a service area, wherein each transmitter is arranged to transmit signals to at least one device in a respective service area. The wireless communications network further comprises at least one transmitter which is arranged to broadcast a content stream as a broadcast service within a respective service area. Said at least one transmitter is further arranged to transmit a broadcast service status message, the broadcast service status message including the service areas for which the broadcast service will soon cease.

There is further provided a device arranged to communicate with a wireless communications network, the device comprising a receiver and a processor. The receiver is arranged to receive a content stream as a broadcast service from the wireless communications network. The receiver is further arranged to receive a broadcast service status message, the broadcast service status message including the service areas for which the broadcast service will soon cease. The processor is arranged to determine, in response to the broadcast service status message, whether to leave the broadcast service and request a unicast service of the content stream.

There is further provided an apparatus for managing a broadcast service within a wireless communications network, the apparatus comprising a processor and a memory. The memory contains instructions executable by said processor whereby said apparatus is operative to: broadcast a content stream as a broadcast service to at least one device using the wireless communications network; and send to the at least one device a broadcast service status message, the broadcast service status message including the service areas for which the broadcast service will soon cease. By receiving an indication that the broadcast service will cease, before the broadcast service is stopped, the device can take steps to avoid buffer under-run, such as requesting and setting up a unicast service of the same content.

There is further provided a computer-readable medium, carrying instructions, which, when executed by computer logic, causes said computer logic to carry out any of the methods defined herein. There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

There is further provided a user terminal comprising a processor and memory, said memory containing instructions executable by said processor whereby said user terminal is operative to: receive a content stream as a broadcast service from the wireless communications network; receive a broadcast service status message, the broadcast service status message including the service areas for which the broadcast service will soon cease; and determine, in response to the broadcast service status message, whether to leave the broadcast service and request a unicast service of the content stream.

There is further provided a user terminal comprising an antenna, display, transceiver, processor and memory, said memory containing instructions executable by said processor whereby said user terminal is operative to: receive a content stream as a broadcast service from the wireless communications network; receive a broadcast service status message, the broadcast service status message including the service areas for which the broadcast service will soon cease; and determine, in response to the broadcast service status message, whether to leave the broadcast service and request a unicast service of the content stream.

The device is adapted to store a message e.g. in a memory such as a flash drive or a hard disk of the device.

### BRIEF DESCRIPTION OF THE DRAWINGS

An MBMS switching improvement will now be described, by way of example only, with reference to the accompanying drawings, in which:

FIG. 1 illustrates a basic implementation of an eMBMS system;

FIG. 2 is a messaging diagram showing a Session Update procedure;

FIG. 3 illustrates a problem addressed by the methods and apparatus described herein;

FIG. 4 illustrates a method in a wireless communications network;

FIG. 5 illustrates an alternative method in a wireless communications network;

FIG. 6 illustrates a method in a device arranged to communicate with a wireless communications network;

FIG. 7 illustrates an advantage of the methods and apparatus described herein;

FIGS. 8A and 8B show an implementation of the service area element described herein;

FIGS. 9A and 9B illustrate an alternative implementation of the service area element;

FIGS. 10A and 10B illustrate a new sessionScheduleOverride element;

FIGS. 11A and 11B illustrate a yet further implementation;

FIG. 12 illustrates a device arranged to communicate with a wireless communications network; and

FIG. 13 illustrates an apparatus for managing a broadcast service within a wireless communications network.

### DETAILED DESCRIPTION

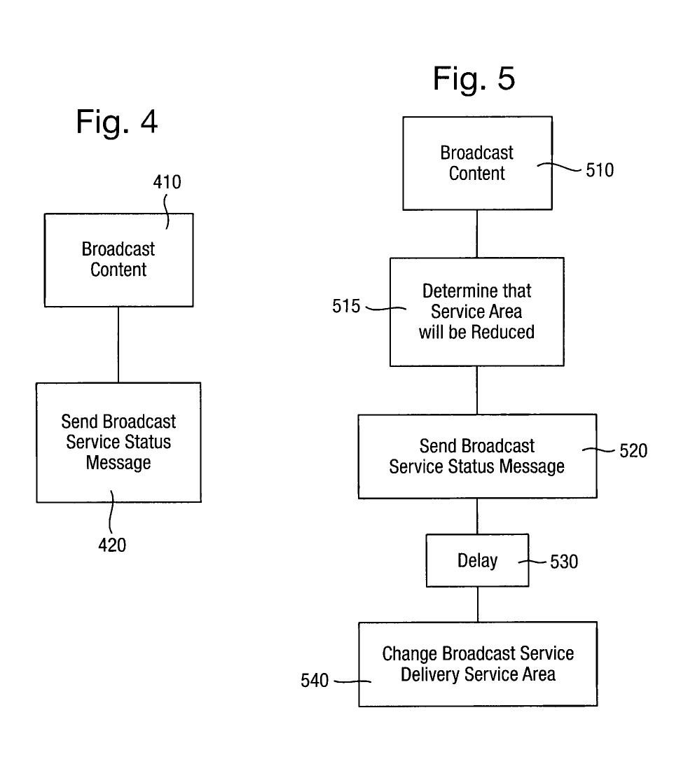

FIG. 4 illustrates a method in a wireless communications network. The method comprises broadcasting 410 a content stream as a broadcast service to at least one device using the wireless communications network. The method further comprises sending 420 to the at least one device a broadcast service status message, the broadcast service status message including the service areas for which the broadcast service will soon cease. By receiving an indication that the broadcast service will cease, before the broadcast service is stopped, the device can take steps to avoid buffer under-run, such as requesting and setting up a unicast service of the same content.

FIG. 5 illustrates an alternative method in a wireless communications network. The method comprises broadcasting 510 a content stream as a broadcast service to at least one device using the wireless communications network. The method further comprises determining 515 that the service areas for which the broadcast service is available should be changed to a revised set of service areas. The method further comprises sending 520 to the at least one device a further broadcast service status message, the further broadcast service status message including the service areas for which the broadcast service is currently available, but that are not in the revised set of service areas. The method comprises a delay 530 subsequent to the broadcast service status message being sent. Then the broadcast service content stream is broadcast 540 as a broadcast service in the revised set of service areas. By receiving an indication that the broadcast service will cease, before the broadcast service is stopped, the device can take steps to avoid buffer under-run, such as requesting and setting up a unicast service of the same content.

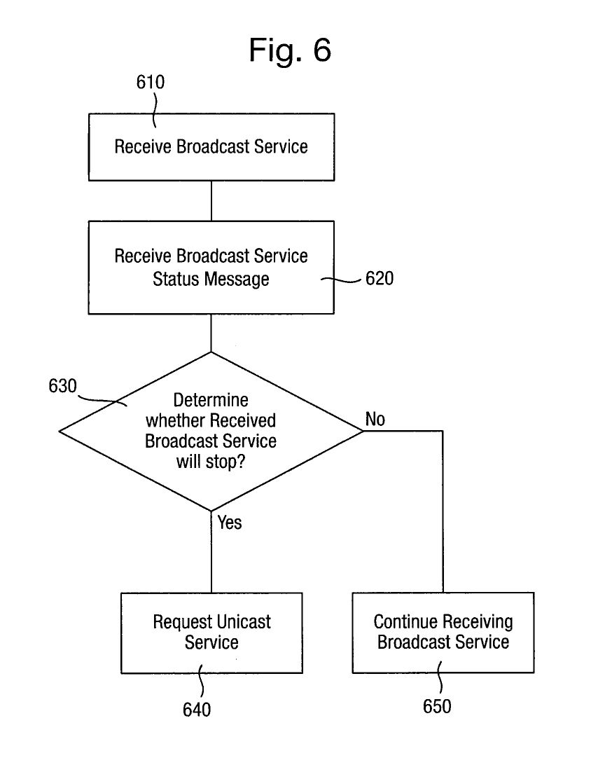

FIG. 6 illustrates a method in a device arranged to communicate with a wireless communications network. The method comprises receiving 610 a content stream as a broadcast service from the wireless communications network. The method further comprises receiving 620 a broadcast service status message, the broadcast service status message including the service areas for which the broadcast service will soon cease. The method further comprises determining 630, in response to the broadcast service status message, whether to leave the broadcast service and request a unicast service of the content stream.

If the broadcast service status message includes the service area the device is in, the device may determine that it will leave the broadcast service and should request 640 a unicast service of the content stream. Otherwise, if the device finds its location is not included in service areas of broadcast service status message, the device determines that it can continue to receive the broadcast service.

Alternatively, if the device is moving and it detects it is moving into a service area included in the most recent broadcast service status message, then the device may also in that situation determine that it will leave the broadcast service and should request 640 a unicast service of the content stream.

However, if the device receiving the broadcast service detects it is moving into a service area not included in the most recent broadcast service status message, then the device may determine that it can continue 650 to receive the broadcast service.

The broadcast service may be MBMS. The device may be a mobile device. The device may be a UE. The device may be an in car entertainment system. The service area may be a cell of a wireless communications network. The service area may be an MBMS Service Area Identity (SAI). The service area may be a Cell Global Identifier (CGI), or an enhanced Cell Global Identifier (eCGI).

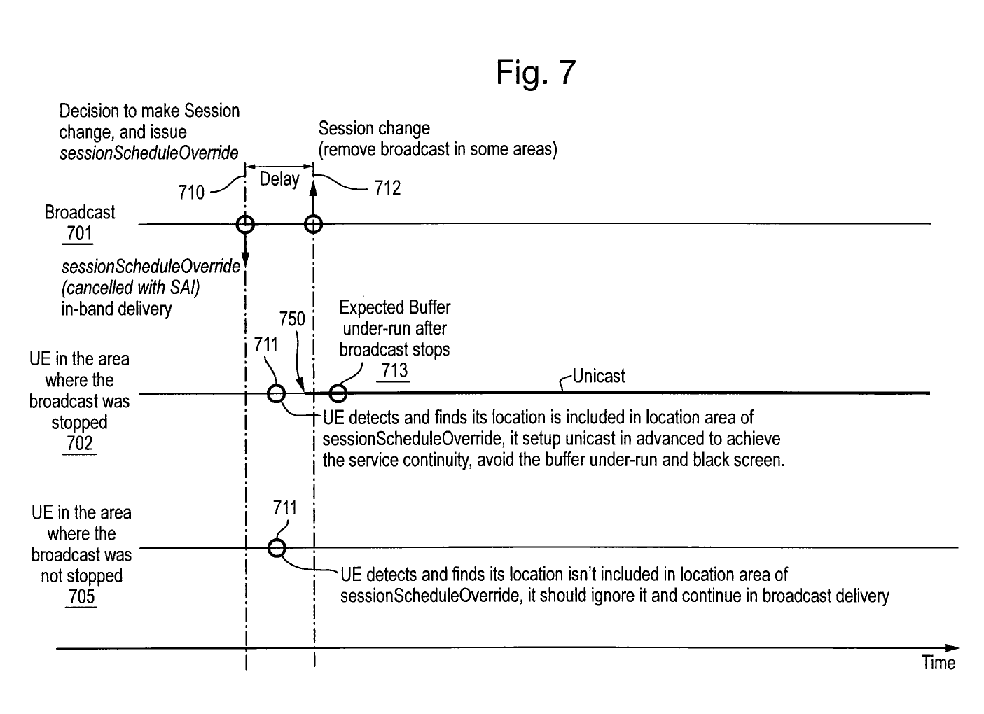

FIG. 7 illustrates an advantage of the methods and apparatus described herein. The broadcast signal 701, and the access to that signal by two different UEs is shown in 702 and 705, all relative to the same time axis. A network apparatus determines that the session area should be reduced by removing at least one service area. This determination is made at time 710, and at that time a broadcast service status message is sent.

The first UE is in a service area where the broadcast session will soon cease. A short time after 710, at time 711 the UE determines that the broadcast service it is receiving will soon end. In response to that determination the UE requests a unicast stream of the service, the unicast reception begins and at 750 the UE switches to outputting the content via the unicast stream. The switch at time 750 is before the broadcast session 712 stops, but more importantly it is before the UE buffer of the multicast service stops at 713.

In contrast, the second UE is in a service area where the broadcast content will continue. The UE access 705 of this second UE shows that at time 711 the UE receives the broadcast service status message and determines that it can continue to receive the broadcast service, which it does.

In an LTE network, the broadcast service status message may be embodied as a modified sessionScheduleOverride message. The existing sessionScheduleOverride message is defined in 3GPP TS 26.346. The following is an example of how this may be modified to incorporate the arrangements described herein.

A sessionScheduleOverride element is defined as a child of the serviceSchedule element. If included, the sessionScheduleOverride element indicates either the cancellation of the session occurrence, or schedule override, as follows:
If the cancelled attribute (a child of sessionScheduleOverride element) is set to “true” or “1”, and the r12:servicearea was not presented, then the transmission of the session identified by the index attribute (a child of sessionScheduleOverride element) is cancelled, and the UE shall cancel any applicable file repair and/or reception reporting for all files belonging to that session. If this session schedule-level cancellation indication in the updated schedule description is received after any of the associated files have already been delivered, then any related file repair, or reception reporting for those files (associated with their parent service(s)), either in progress or yet to occur, shall be aborted.
If the cancelled attribute (a child of sessionScheduleOverride element) is set to “true” or “1”, and the r12:servicearea was presented with specific areas, then the transmission of the session in these areas is cancelled. The UEs located in these areas shall stop the broadcast receiving and the consequent associated delivery procedure; they should switch to unicast access to consume the service. The UEs were not located in these areas may ignore the sessionScheduleOverride.
If the cancelled attribute (a child of sessionScheduleOverride element) is set to “false” or “0” or is absent, then the start and stop time elements (children of sessionScheduleOverride element) shall override the nominal start and stop time of the transmission schedule of the session as identified by the index attribute (a child of sessionScheduleOverride element).

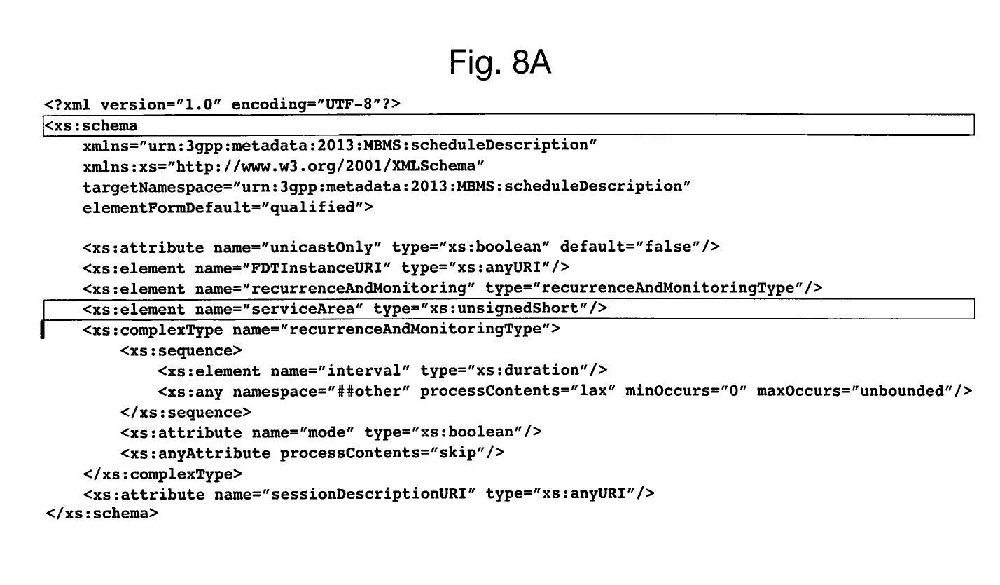

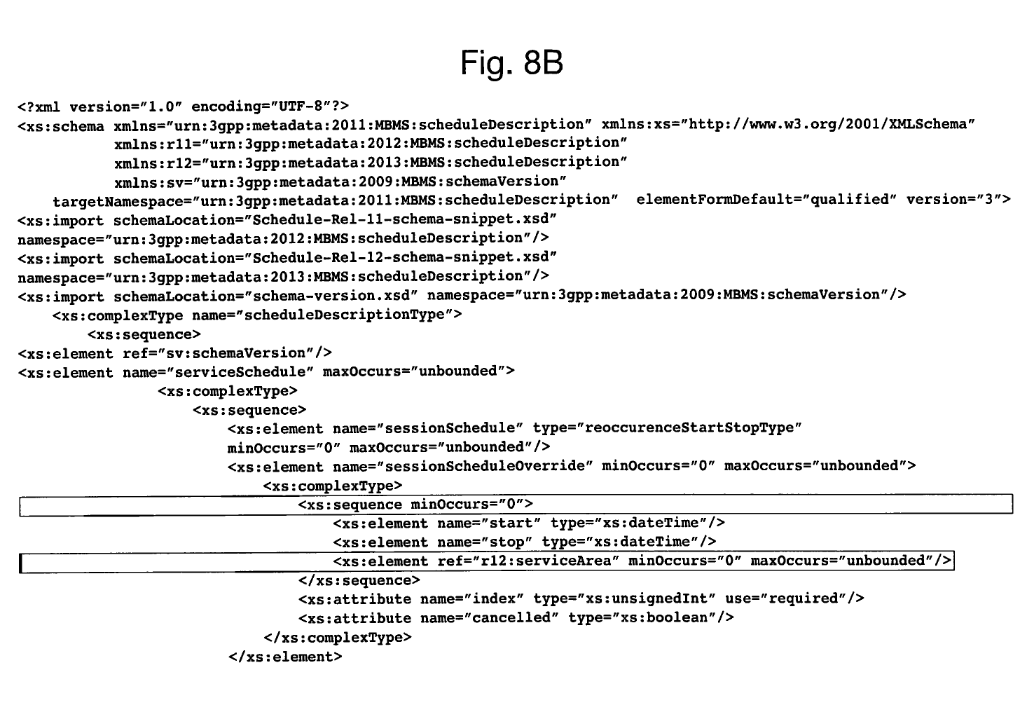

FIGS. 8A and 8B show how the service area element is implemented. FIG. 8A illustrates a new extension schema for the schedule fragment. FIG. 8B illustrates the modified main schedule schema. When the BM-SC receives the update procedure to change the service area, BM-SC should generate the sessionScheduleOverride including the stopped service area(s) if the update including remove some areas, and deliver the schedule fragment in in-band session. Some delay time after the schedule fragment was delivered, the BM-SC send the session update procedure to MBMS-GW to change the broadcast session. The update could include add new areas and remove some existing areas.

A UE that is located in the area where the broadcast will soon be stopped will, upon it receiving the sessionScheduleOverride including the stopped service area(s), setup unicast access in advanced to achieve the service continuity. A UE that is located in the area where the broadcast was not impacted will, when it receives the sessionScheduleOverride including the stopped service area(s), ignore it and continue the broadcast delivery.

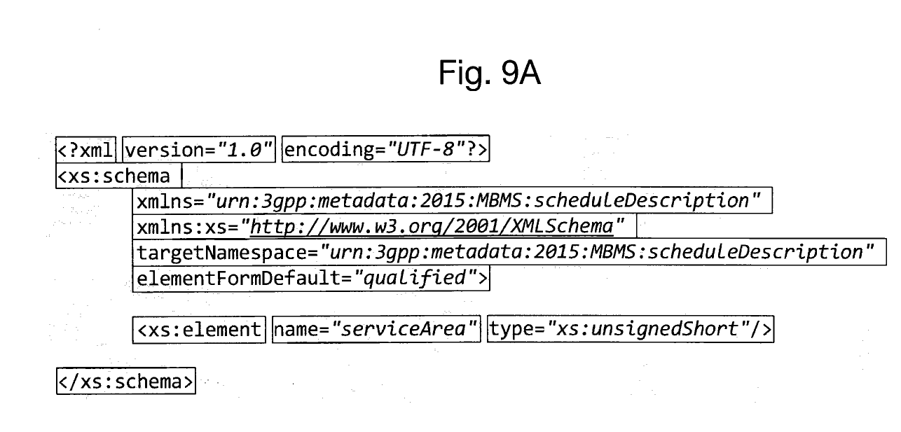

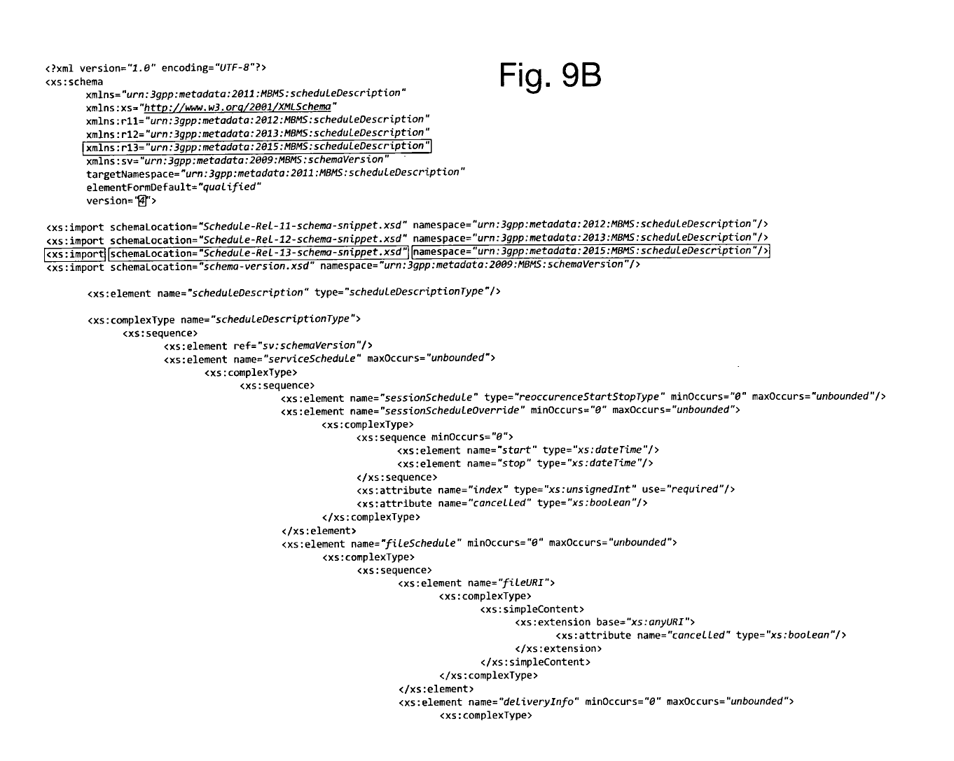

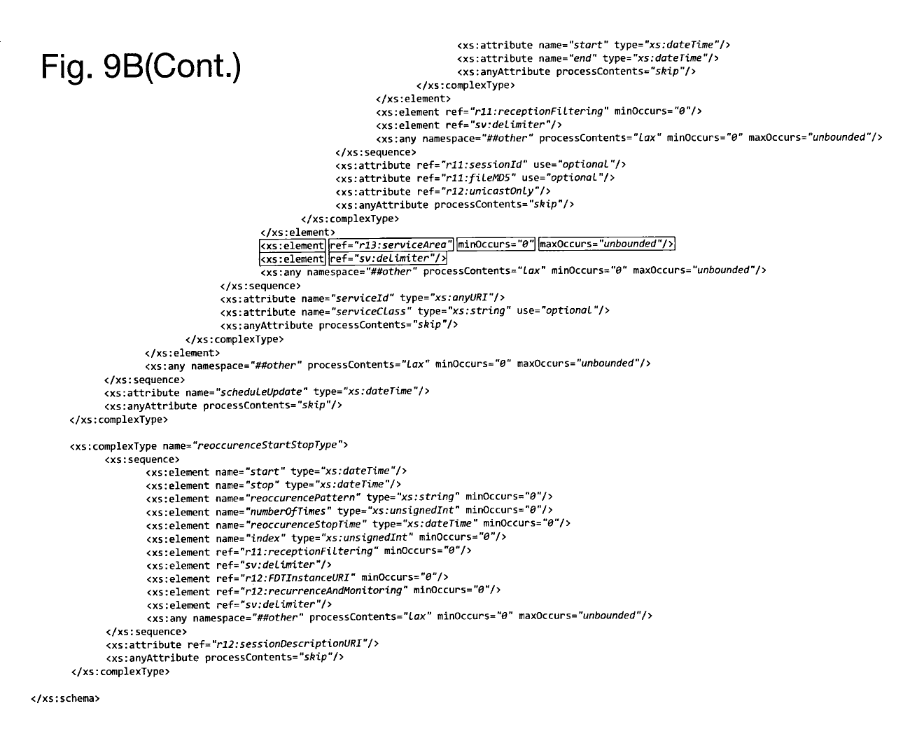

FIG. 9 illustrates an alternative implementation. FIG. 9A illustrates a new extension schema for the schedule fragment. FIG. 9B illustrates the modified main Schedule schema. The logic for this implementation of sessionScheduleOverride is as follows:
If the cancelled attribute (a child of sessionScheduleOverride element) is set to “true” or “1”, and the r13:serviceArea element (a child of the serviceSchedule element) was not presented, then the transmission of the session identified by the index attribute (a child of sessionScheduleOverride element) is cancelled, and the UE shall cancel any applicable file repair and/or reception reporting for all files belonging to that session. If this session schedule-level cancellation indication in the updated schedule description is received after any of the associated files have already been delivered, then any related file repair, or reception reporting for those files (associated with their parent service(s)), either in progress or yet to occur, shall be aborted.
If the cancelled attribute (a child of sessionScheduleOverride element) is set to “true” or “1”, and one or more r13:serviceArea elements (child of the serviceSchedule element) were present, then the transmission of the session in these areas is cancelled. The UEs located in these areas shall stop the broadcast reception and the corresponding associated delivery procedure; then the UE should switch to unicast access to consume the service. The UEs were not located in these areas, they could ignore the sessionScheduleOverride.
If the cancelled attribute (a child of sessionScheduleOverride element) is set to “false” or “0” or is absent, then the start and stop time elements (children of sessionS cheduleOverride element) shall override the nominal start and stop time of the transmission schedule of the session as identified by the index attribute (a child of sessionScheduleOverride element).

When the BM-SC receives the update procedure to change the service area, BM-SC should generate the sessionScheduleOverride including the stopped service area(s) if the update including remove some areas, and deliver the schedule fragment in in-band session. After the schedule fragment was delivered some time (i.e. 1 minute), BM-SC send the session update procedure to MBMS-GW to change the broadcast session. The update could include add new areas and remove some existing areas.

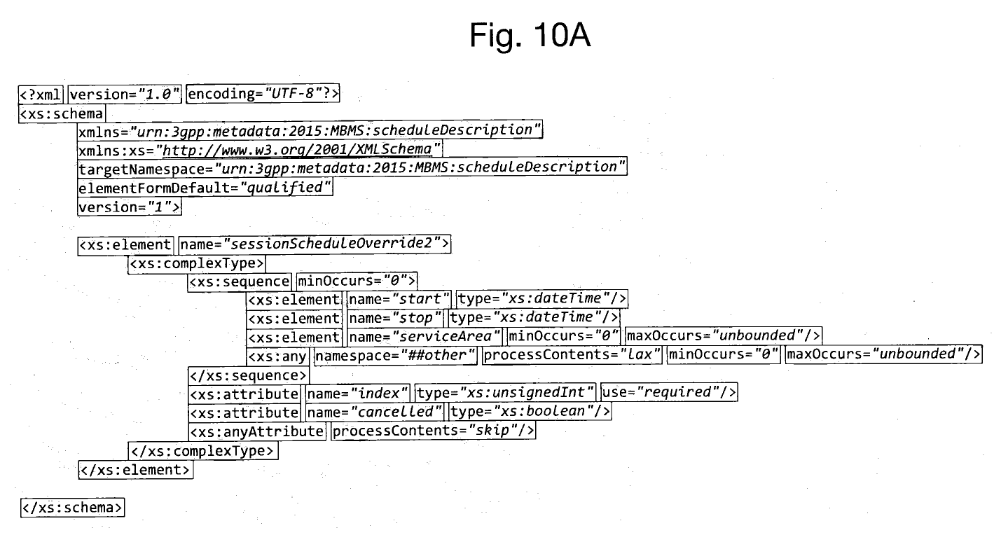

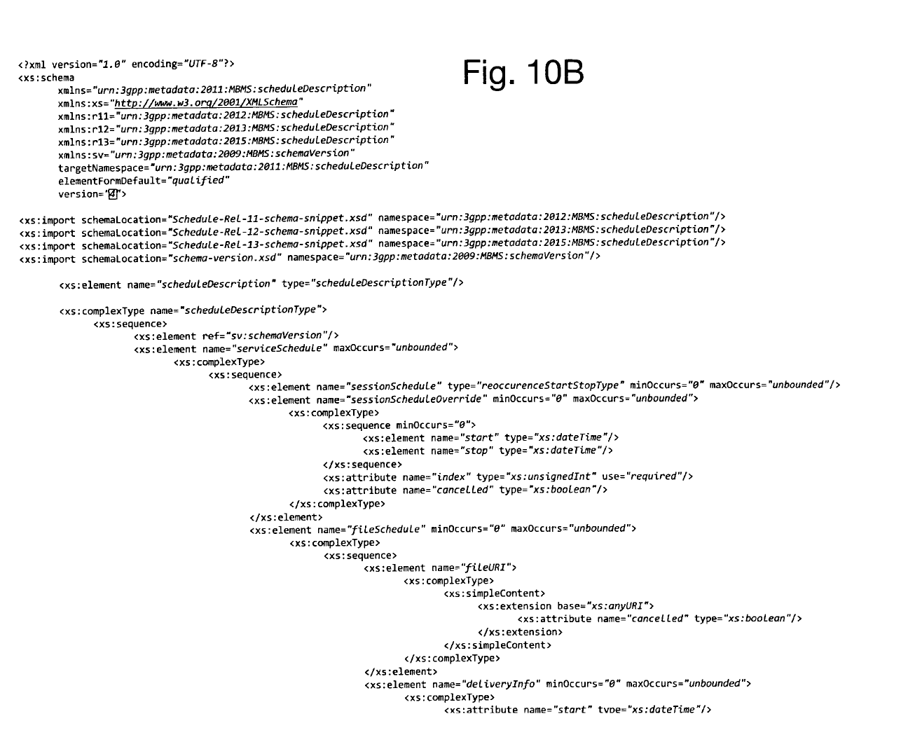

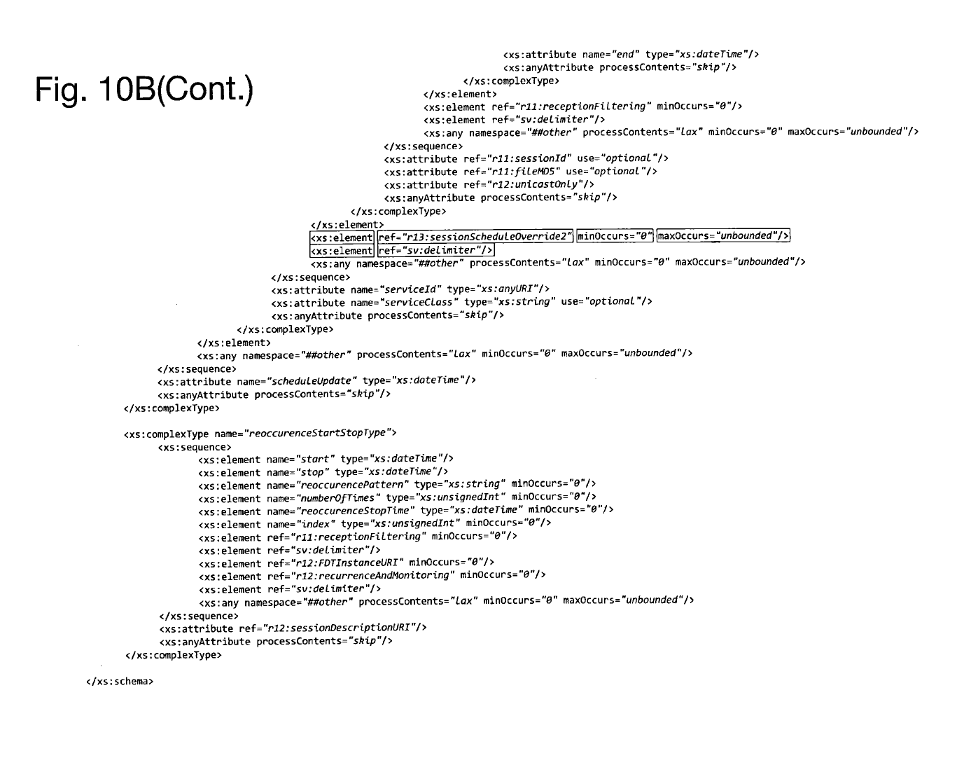

In a further alternative, illustrated in FIG. 10, a new sessionScheduleOverride, is defined. Here we call this sessionScheduleOverride2. This new element deprecates the old one. FIG. 10 illustrates how the schema in this embodiment looks. Note that it includes both sessionScheduleOverride and sessionScheduleOverride2. In particular, FIG. 10A shows a new extension for the schedule fragment, and FIG. 10B shows the main schedule schema as it looks under this embodiment.

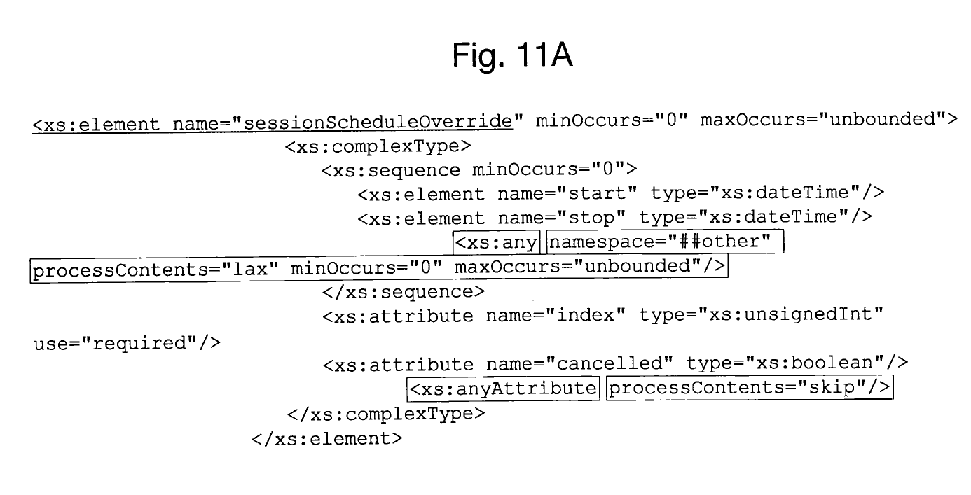

A yet further alternative is illustrated in FIG. 11. FIG. 11A illustrates a new extension schema for the schedule fragment according to this alternative and FIG. 11B illustrates the modified main schedule schema.

A sessionScheduleOverride element is defined as a child of the serviceSchedule element. If included, the sessionScheduleOverride element indicates either the cancellation of the session occurrence, or schedule override, as follows:
If the cancelled attribute (a child of sessionScheduleOverride element) is set to “true” or “1”, and the r13:servicearea was not presented, then the transmission of the session identified by the index attribute (a child of sessionScheduleOverride element) is cancelled, and the UE shall cancel any applicable file repair and/or reception reporting for all files belonging to that session. If this session schedule-level cancellation indication in the updated schedule description is received after any of the associated files have already been delivered, then any related file repair, or reception reporting for those files (associated with their parent service(s)), either in progress or yet to occur, shall be aborted.
If the cancelled attribute (a child of sessionScheduleOverride element) is set to “true” or “1”, and the r13:servicearea was presented with specific areas, then the transmission of the session in these areas is cancelled. The UEs located in these areas shall stop the broadcast receiving and the consequent associated delivery procedure; they should switch to unicast access to consume the service. The UEs were not located in these areas may ignore the sessionScheduleOverride.
If the cancelled attribute (a child of sessionScheduleOverride element) is set to “false” or “0” or is absent, then the start and stop time elements (children of sessionScheduleOverride element) shall override the nominal start and stop time of the transmission schedule of the session as identified by the index attribute (a child of sessionScheduleOverride element).

When the BM-SC receives the update procedure to change the service area, BM-SC should generate the sessionScheduleOverride including the stopped service area(s) if the update including remove some areas, and deliver the schedule fragment in in-band session. Some delay time after the schedule fragment was delivered, the BM-SC send the session update procedure to MBMS-GW to change the broadcast session. The update could include add new areas and remove some existing areas.

A UE that is located in the area where the broadcast will soon be stopped will, upon it receiving the sessionScheduleOverride including the stopped service area(s), setup unicast access in advanced to achieve the service continuity. A UE that is located in the area where the broadcast was not impacted will, when it receives the sessionScheduleOverride including the stopped service area(s), ignore it and continue the broadcast delivery.

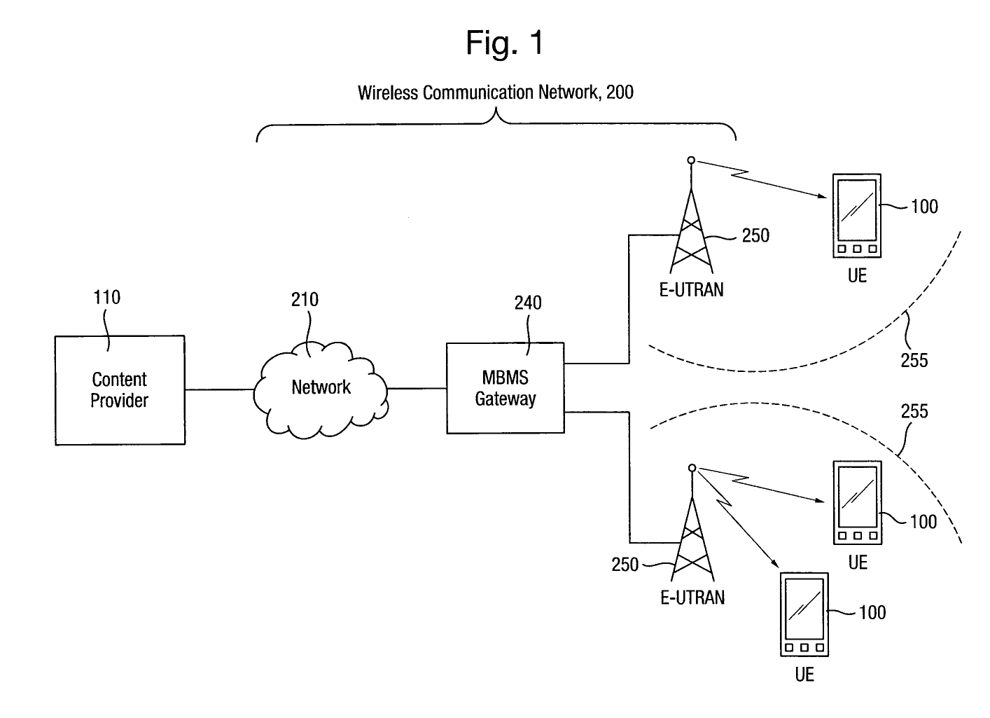

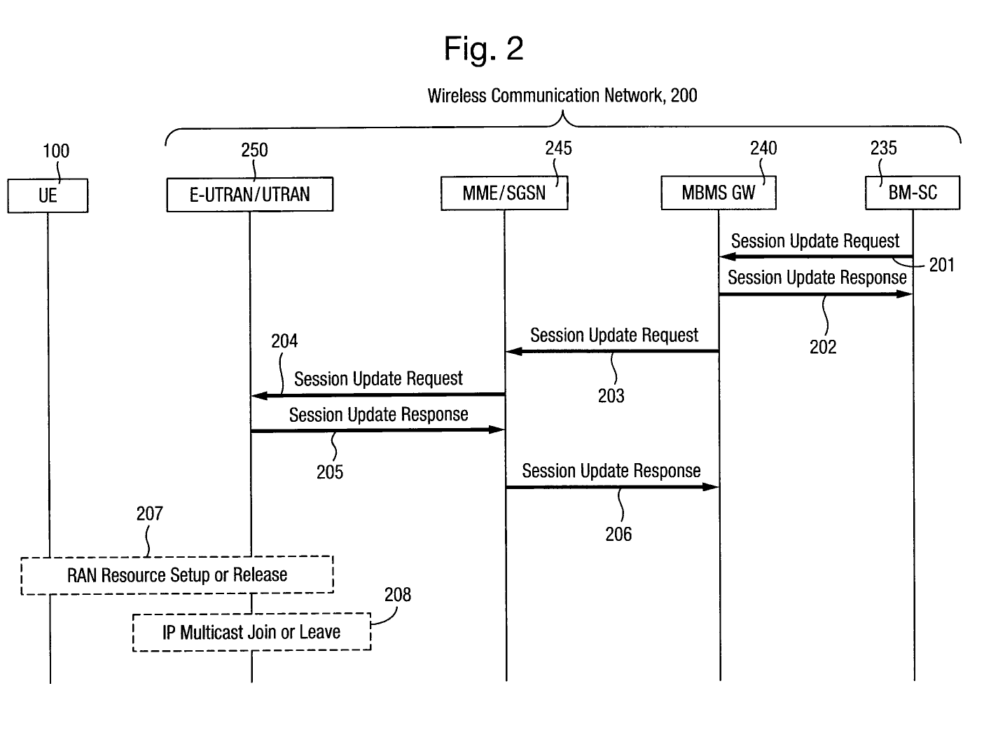

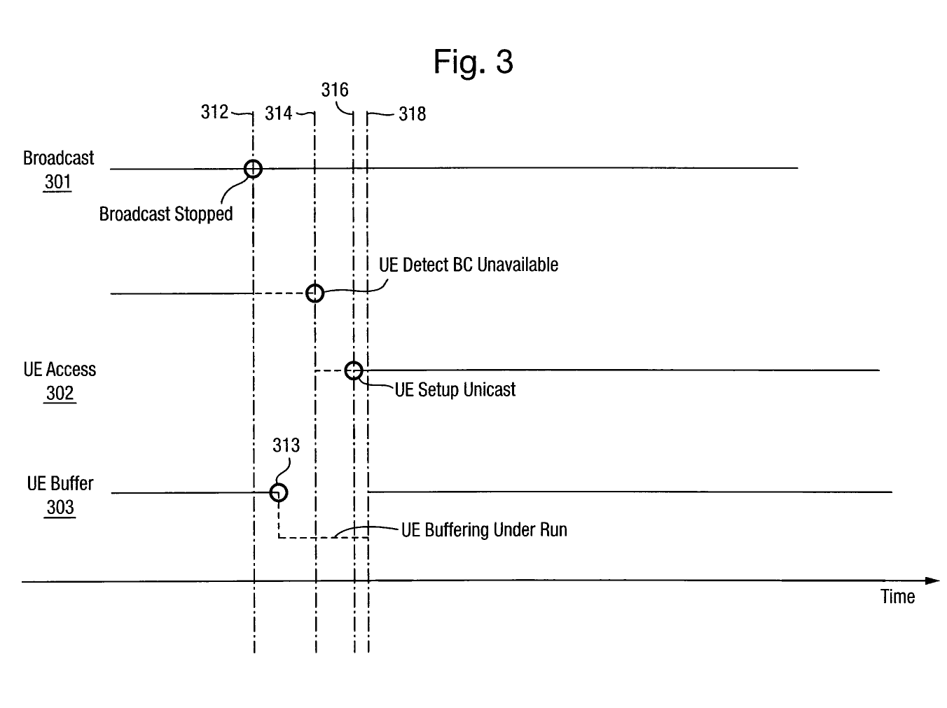

The wireless communications network 200 of FIG. 1 may be modified to incorporate the methods described herein. A modified wireless communications network 200, comprises a plurality of transmitters 250, each transmitter having a service area 255, wherein each transmitter is arranged to transmit signals to at least one device 100 in a respective service area 255. The wireless communications network further comprises at least one transmitter 250 that is arranged to broadcast a content stream as a broadcast service within a respective service area 255. Said at least one transmitter 250 is further arranged to transmit a broadcast service status message, the broadcast service status message including the service areas 255 for which the broadcast service will soon cease.

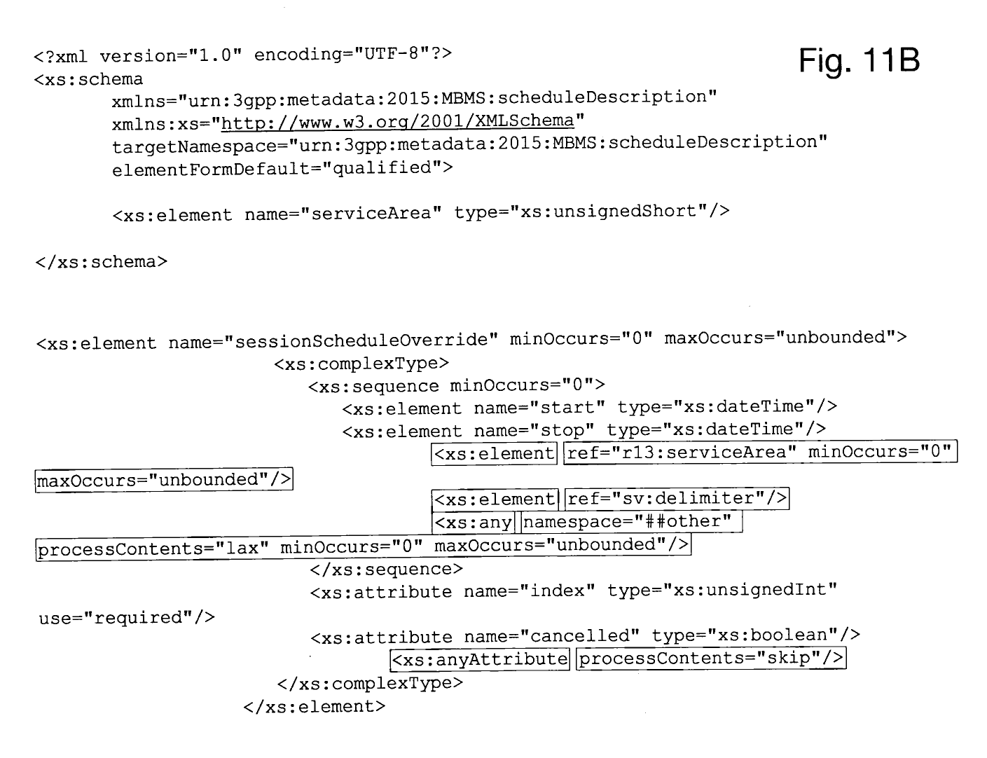

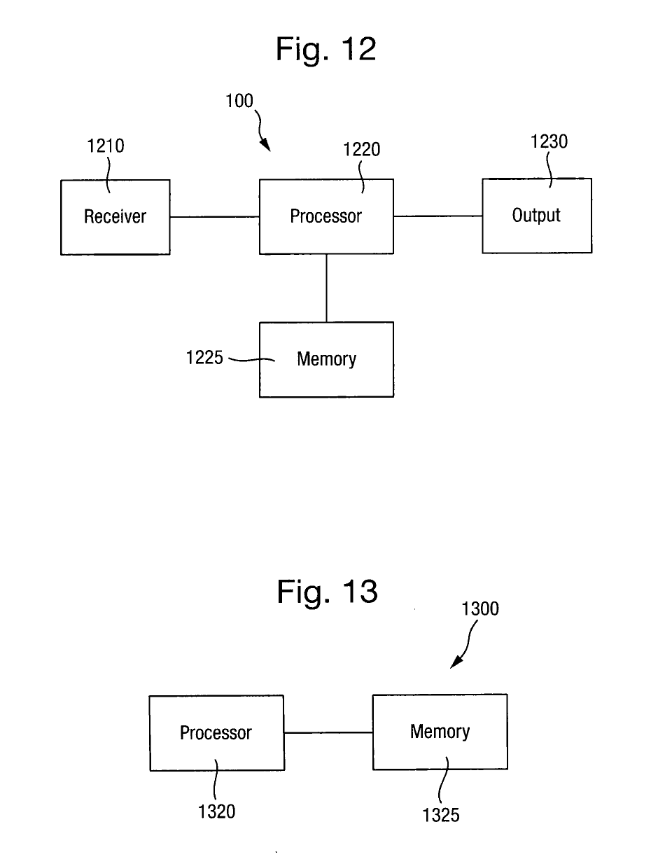

FIG. 12 illustrates a device 100 arranged to communicate with a wireless communications network 200, the device 100 comprising a receiver 1210 and a processor 1220. The receiver 1210 is arranged to receive a content stream as a broadcast service from the wireless communications network 200. The receiver 1210 is further arranged to receive a broadcast service status message, the broadcast service status message including the service areas 255 for which the broadcast service will soon cease. The processor 1220 is arranged to determine, in response to the broadcast service status message, whether to leave the broadcast service and request a unicast service of the content stream.

The device 100 of FIG. 12 further comprises a memory 1225. The processor 1220 is arranged to receive instructions which, when executed, causes the processor 1220 to carry out the above described method. The instructions may be stored on the memory 1225. The device 100 of FIG. 12 further comprises an output 1230, the output 1230 suitable for outputting received video. Output 1230 may comprise a screen such as an LCD panel, or a connection such as HDMI for sending video to a screen.

FIG. 13 illustrates an apparatus 1300 for managing a broadcast service within a wireless communications network 200, the apparatus 1300 comprising a processor 1320 and a memory 1325, said memory 1325 containing instructions executable by said processor 1320 whereby said apparatus 1300 is operative to: broadcast a content stream as a broadcast service to at least one device 100 using the wireless communications network 200; and send to the at least one device a broadcast service status message, the broadcast service status message including the service areas for which the broadcast service will soon cease. By receiving an indication that the broadcast service will cease, before the broadcast service is stopped, the device can take steps to avoid buffer under-run, such as requesting and setting up a unicast service of the same content.

There is further provided a computer-readable medium, carrying instructions, which, when executed by computer logic, causes said computer logic to carry out any of the methods defined herein. There is further provided a computer-readable storage medium, storing instructions, which, when executed by computer logic, causes said computer logic to carry out any of the methods defined herein. The computer program product may be in the form of a non-volatile memory or volatile memory, e.g. an EEPROM (Electrically Erasable Programmable Read-only Memory), a flash memory, a disk drive or a RAM (Random-access memory).

There is further provided a user terminal comprising a processor and memory, said memory containing instructions executable by said processor whereby said user terminal is operative to: receive a content stream as a broadcast service from the wireless communications network; receive a broadcast service status message, the broadcast service status message including the service areas for which the broadcast service will soon cease; and determine, in response to the broadcast service status message, whether to leave the broadcast service and request a unicast service of the content stream.

There is further provided a user terminal comprising an antenna, display, transceiver, processor and memory, said memory containing instructions executable by said processor whereby said user terminal is operative to: receive a content stream as a broadcast service from the wireless communications network; receive a broadcast service status message, the broadcast service status message including the service areas for which the broadcast service will soon cease; and determine, in response to the broadcast service status message, whether to leave the broadcast service and request a unicast service of the content stream.

The device is adapted to store a message e.g. in a memory such as a flash drive or a hard disk of the device.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope

The above described method may be carried out by suitably adapted hardware, such as an adapted form of the exemplary hardware implementation of a communications device as shown in FIG. 12. or network apparatus as shown in FIG. 13, where the adaptation involves providing additional components or interfaces not shown in these figures.

The method may also be embodied in a set of instructions, stored on a computer readable medium, which when loaded into a computer processor, Digital Signal Processor (DSP) or similar, causes the processor to carry out the hereinbefore described improved MBMS switching method.

Equally, the method may be embodied as a specially programmed, or hardware designed, integrated circuit which operates to carry out the method on video data loaded into the said integrated circuit. The integrated circuit may be formed as part of a general purpose computing device, such as a PC, and the like, or it may be formed as part of a more specialised device, such as a games console, mobile phone, portable computer device or hardware video encoder.

One exemplary hardware embodiment is that of a Field Programmable Gate Array (FPGA) programmed to carry out the described method, located on a daughterboard of a rack mounted network device, for use in, for example, a network base station.

Another exemplary hardware embodiment of the methods described herein is that of a network device comprising an Application Specific Integrated Circuit (ASIC).

The client device may be a user apparatus. The client device may be any kind of personal computer such as a television, a smart television, a set-top box, a games-console, a home-theatre personal computer, a tablet, a smartphone, a laptop, a desktop PC, or even an in-car entertainment system.

Further, while examples have been given in the context of particular communications standards, these examples are not intended to be the limit of the communications standards to which the disclosed method and apparatus may be applied. For example, while specific examples have been given in the context of LTE, the principles disclosed herein can also be applied to any WCDMA system, other wireless communication system, and indeed any communication system which uses multicast service areas.

### REFERENCES

3GPP TS 26.246

3GPP TS 26.346

3GPP TS 29.061

1-24. (canceled)

25. A method in a wireless communications network, the method comprising:
broadcasting a content stream as a broadcast service to at least one device using the wireless communications network; and
sending to the at least one device a broadcast service status message, the broadcast service status message indicating one or more service areas for which the broadcast service shall be terminated.

26. The method of claim 25, further comprising determining the one or more service areas for which the broadcast service shall be terminated.

27. The method of claim 25, further comprising delaying between sending the broadcast service status message and terminating the broadcast service in the one or more service areas indicated in the broadcast service status message.

28. The method of claim 25, wherein broadcasting the content stream as a broadcast service comprises broadcasting the stream in a current set of service areas, and wherein sending the broadcast service status message indicating one or more service areas for which the broadcast service shall be terminated is based on:
deciding to revise the current set of service areas;
indicating in the broadcast service status message any service areas that are in the current set of service areas but not in the revised set of service areas; and
after a delay, initiating or continuing the broadcast service in the service areas included in the revised set of service areas and terminating the broadcast service in any service area that were included in the current set of service areas but not included in the revised set of service areas.

29. The method of claim 25, wherein each of the one or more service areas is a cell of a wireless communications network.

30. A method in a device configured to communicate with a wireless communications network, the method comprising:
receiving a content stream as a broadcast service from the wireless communications network;
receiving a broadcast service status message, the broadcast service status message indicating one or more service areas for which the broadcast service shall be terminated; and
determining, in response to the broadcast service status message, whether to leave the broadcast service and request a unicast service of the content stream.

31. The method of claim 30, wherein, responsive to determining that a current service area of the device is one of the one or more indicated service areas, determining that the device shall leave the broadcast service and, correspondingly, requesting a unicast service of the content stream.

32. The method of claim 30, wherein, responsive to determining that a current service area of the device is not one of the one or more indicated service areas, determining that the broadcast service remains available to the device.

33. The method of claim 30, wherein the broadcast service status message is a most recent broadcast status service message received by the device from the network, and wherein the method further comprises, responsive to detecting that the device is moving into one of the one or more services areas indicated in the most recent broadcast service status message received by the device, determining that the broadcast service will become unavailable to the device and, in response to the unavailability or in advance of the unavailability, requesting a unicast service of the content stream.

34. The method of claim 30, wherein the broadcast service status message is a most recent broadcast status service message received by the device from the network, and wherein the method further comprises, responsive to detecting that the device is moving into a service area that is not one of the one or more services areas indicated in the most recent broadcast service status message received by the device, determining that the broadcast service remains available to the device.

35. The method of claim 30, wherein each of the one or more service areas is a cell of a wireless communications network.

36. A device configured to communicate with a wireless communications network, the device comprising:
a receiver configured to receive a content stream as a broadcast service from the wireless communications network,
the receiver further configured to receive a broadcast service status message, the broadcast service status message indicating one or more service areas for which the broadcast service shall be terminated; and
a processor configured to determine, in response to the broadcast service status message, whether to leave the broadcast service and request a unicast service of the content stream.

37. The device of claim 36, wherein the processor is configured to, responsive to determining that a current service area of the device is one of the one or more indicated service areas, determine that the device shall leave the broadcast service and, correspondingly, request a unicast service of the content stream.

38. The device of claim 34, wherein the processor is configured to, responsive to determining that a current service area of the device is not one of the one or more indicated service areas, determine that the broadcast service remains available to the device.

39. An apparatus configured for managing a broadcast service within a wireless communications network, the apparatus comprising a processor and a memory, the memory containing instructions executable by the processor whereby the apparatus is operative to:
broadcast a content stream as a broadcast service to at least one device using the wireless communications network; and
send to the at least one device a broadcast service status message, the broadcast service status message indicating one or more service areas for which the broadcast service shall be terminated.
